(19) United States
(12) Patent Application Publication
(10) Pub. No.: US 2026/0162450 A1
(43) Pub. Date: Jun. 11, 2026

(54) VIDEO TAG GENERATION METHOD AND APPARATUS, ELECTRONIC DEVICE, AND STORAGE MEDIUM

(71) Applicant: TENCENT TECHNOLOGY (SHENZHEN) COMPANY LIMITED, Shenzhen (CN)

(72) Inventors: Yulin YANG, Shenzhen (CN); Shizhe CHEN, Shenzhen (CN); Xiao LIU, Shenzhen (CN)

(21) Appl. No.: 19/179,611

(22) Filed: Apr. 15, 2025

Related U.S. Application Data
(63) Continuation of application No. PCT/CN2024/078647, filed on Feb. 27, 2024.

(30) Foreign Application Priority Data
Mar. 13, 2023 (CN) 202310261084.3

(51) Int. Cl. G06V 20/70; G06V 40/16

(52) U.S. Cl. CPC G06V 20/70; G06V 40/16

(57) ABSTRACT

In a video tag generation method, a plurality of key frames are extracted from a video, personal names corresponding to the key frames are extracted to form a candidate personal name set, an auxiliary personal name set is extracted from video auxiliary information, the candidate personal name set is screened by using the auxiliary personal name set to obtain a target personal name set, and each personal name in the target personal name set is taken as a personal name tag of the video.

### CROSS-REFERENCES TO RELATED APPLICATIONS

This application is a continuation of PCT Application No. PCT/CN2024/078647, filed on Feb. 27, 2024, which claims priority to Chinese Patent Application No. 202310261084.3 filed with the China National Intellectual Property Administration on Mar. 13, 2023 and entitled “VIDEO TAG GENERATION METHOD AND APPARATUS, ELECTRONIC DEVICE, AND STORAGE MEDIUM”, the entire contents of both of which are incorporated herein by reference.

### FIELD OF THE TECHNOLOGY

The present disclosure relates to the field of computer technologies, and in particular, to a video tag generation method and apparatus, an electronic device, and a storage medium.

### BACKGROUND OF THE DISCLOSURE

In recent years, computer network technologies, digital television technologies, and communication technologies have become increasingly mature, and greatly accelerated rise of a multimedia industry. The multimedia industry has been taking technologies such as images, animations, graphics, and sounds as a core, taking a digital medium as a carrier, covering content of a plurality of fields such as information, propagation, advertisements, communication, electronic entertainment products, network education, entertainment, and publishing. The multimedia industry relates to a plurality of industries such as computers, movies and televisions, media, and education, which is regarded as a core industry of knowledge economy in the 21st century, and is another economic growth point after IT industry.

With rapid development of the computer network technologies and widespread adoption of multimedia applications, vast amounts of video content are continuously being generated. Therefore, extracting content of interest from massive video datasets becomes a focus in current multimedia application research.

### SUMMARY

Embodiments of the present disclosure provide a video tag generation method and apparatus, an electronic device, and a storage medium, which are configured for generating a personal name tag for video recommendation.

The embodiments of the present disclosure provide a video tag generation method. The method is performed by a server, and the method includes: obtaining a video and obtaining video auxiliary information, the video auxiliary information including at least one of text information and picture information; extracting a plurality of key frames from the video, performing face recognition on each key frame to obtain a recognition result corresponding to each key frame, and extracting, based on each recognition result, a personal name corresponding to a corresponding key frame to obtain a candidate personal name set comprising personal names corresponding to the plurality of key frames; performing personal name extraction on the video auxiliary information to obtain an auxiliary personal name set, the auxiliary personal name set including at least one personal name and a personal name source of each personal name; obtaining an importance feature of each personal name in the candidate personal name set based on the auxiliary personal name set, the importance feature of each personal name including a feature vector indicating the personal name source of the corresponding personal name; and determining a target personal name set by screening the candidate personal name set based on the importance feature of each personal name; and taking each personal name in the target personal name set as a personal name tag of the video.

The embodiments of the present disclosure provide a video tag generation apparatus, applied to a server. The apparatus includes: a multimodal information obtaining module, configured to obtain a video, and obtain video auxiliary information, the video auxiliary information including at least one of text information and picture information; a candidate personal name extraction module, configured to extract a plurality of key frames from the video, perform face recognition on each key frame to obtain a recognition result corresponding to each key frame, and extract, based on each recognition result, a personal name corresponding to a corresponding key frame to obtain a candidate personal name set comprising personal names corresponding to the plurality of key frames; an auxiliary personal name extraction module, configured to perform, based on modality types of the video auxiliary information, personal name extraction on the video auxiliary information to obtain an auxiliary personal name set, the auxiliary personal name set including at least one personal name and a personal name source of each personal name; a personal name screening module, configured to: obtain an importance feature of each personal name in the candidate personal name set based on the auxiliary personal name set, the importance feature of each personal name including a feature vector indicating the personal name source of the corresponding personal name, and screen a target personal name set from the candidate personal name set based on the importance feature of each personal name; and a tag generation module, configured to take each personal name in the target personal name set as a personal name tag of the video.

The embodiments of the present disclosure provide an electronic device, including a processor and a memory. The memory stores a computer program, and the computer program, when executed by the processor, implements the operations of the foregoing video tag generation method.

The embodiments of the present disclosure provide a non-transitory computer-readable storage medium, having computer-readable instructions stored therein. The computer-readable instructions, when executed by an electronic device, implement the operations of the foregoing video tag generation method.

Features and advantages of the present disclosure will be described in the following specification, and moreover, part will become apparent from the specification or may be learned through implementation of the present disclosure. Objectives and other advantages of the present disclosure may be implemented and obtained through structures particularly pointed out in the written specification, claims, and accompanying drawings.

### BRIEF DESCRIPTION OF THE DRAWINGS

FIG. 1 is a diagram of an application scenario applicable to an embodiment of the present disclosure.

FIG. 2 is a schematic diagram of a tag application process of a video according to an embodiment of the present disclosure.

FIG. 3 is an overall architecture diagram of a video tag generation method according to an embodiment of the present disclosure.

FIG. 4 is a flowchart of a video tag generation method according to an embodiment of the present disclosure.

FIG. 5 is a schematic diagram of a process of extracting a candidate personal name according to an embodiment of the present disclosure.

FIG. 6 is a fuzzy matching process of a personal name tag according to an embodiment of the present disclosure.

FIG. 7 is a flowchart of extracting a personal name from text information according to an embodiment of the present disclosure.

FIG. 8 is a flowchart of performing personal name extraction on a piece of text information according to an embodiment of the present disclosure.

FIG. 9 is a schematic diagram of a process of extracting a personal name from text information according to an embodiment of the present disclosure.

FIG. 10 is a schematic diagram of a process of extracting a personal name from picture information according to an embodiment of the present disclosure.

FIG. 11 is a flowchart of a method for training a target screening model according to an embodiment of the present disclosure.

FIG. 12 is a flowchart of a method for updating a candidate personal name in a training sample set according to an embodiment of the present disclosure.

FIG. 13 is a schematic diagram of a process of updating a candidate personal name in a training sample set according to an embodiment of the present disclosure.

FIG. 14 is a diagram of a network structure of a target screening model according to an embodiment of the present disclosure.

FIG. 15 is a flowchart of a method for screening a target personal name according to an embodiment of the present disclosure.

FIG. 16 is a schematic diagram of a process of determining a key person evaluation value according to an embodiment of the present disclosure.

FIG. 17 is a schematic diagram of an overall process of tagging a video with a personal name tag according to an embodiment of the present disclosure.

FIG. 18 is a schematic diagram of a service response process based on a personal name tag according to an embodiment of the present disclosure.

FIG. 19 is a structural diagram of a video tag generation apparatus according to an embodiment of the present disclosure.

FIG. 20 is a structural diagram of an electronic device according to an embodiment of the present disclosure.

### DESCRIPTION OF EMBODIMENTS

To make objectives, technical solutions, and advantages of embodiments of the present disclosure clearer, the technical solutions in the embodiments of the present disclosure are clearly and completely described with reference to accompanying drawings in the embodiments of the present disclosure. Apparently, the described embodiments are merely some embodiments rather than all of the embodiments of the technical solutions of the present disclosure. All other embodiments obtained by those of ordinary skill in the art based on the embodiments recorded in a document of the present disclosure fall within the scope of protection of the technical solutions of the present disclosure.

For ease of understanding, nouns involved in the embodiments of the present disclosure are explained below.

Video: Videos usually refer to storage formats of various dynamic images, and include long videos and short videos according to time lengths of the dynamic images. The time length of the long video is greater than the time length of the short video.

Tag system: A tag system refers to a system that can tag a video with various rich tags, such as a drama name, a song name, an item, a scenario, and a personal name of the video. The tagged tags are configured for downstream services such as recommendation, search, and distribution.

Video auxiliary information: Video auxiliary information refers to related content associated with a video, and may have a plurality of modalities, such as text information, picture information, and voice information.

Text information: Text information refers to video auxiliary information in a character string format, such as text extracted from a title, a subtitle, a comment, and a picture of a video.

Picture information: Picture information refers to video auxiliary information in a picture format, such as a cover picture, a poster, and an extracted video frame of a video.

Multimodal information extraction and fusion: Information in a plurality of modalities included in video auxiliary information is encoded into dense feature vectors by using a machine learning method or a deep learning method, which is referred to as multimodal information extraction and fusion.

Optical character recognition (OCR): The OCR is configured for converting an image shape into text characters, that is, for any input picture, all text in the picture can be outputted.

Character string edit distance: A character string edit distance is quantitative measurement for degree of deviation between two character strings. A measurement mode is to count times of processing required to convert one character string into another character string.

Embodiments of the present disclosure relate to artificial intelligence (AI), and are designed based on a big data analysis technology and a machine learning (ML) technology in an AI technology. AI involves a theory, a method, a technology, and an application system that use a digital computer or a machine controlled by the digital computer to simulate, extend, and expand human intelligence, perceive an environment, obtain knowledge, and use knowledge to obtain an optimal result. In other words, AI is a comprehensive technology in computer science and attempts to understand the essence of intelligence and produce a new intelligent machine that can react in a mode similar to human intelligence. AI is to study the design principles and implementation methods of various intelligent machines, to enable the machines to have the functions of perception, reasoning, and decision-making.

The AI technology is a comprehensive discipline, and relates to a wide range of fields including both hardware-level technologies and software-level technologies. The basic AI technologies generally include technologies such as a sensor, a dedicated AI chip, cloud computing, distributed storage, a big data processing technology, an operating/interaction system, and electromechanical integration. AI software technologies mainly include several major directions such as a computer vision technology, a speech processing technology, a natural language processing technology, and ML/Deep Learning (DL).

ML is a multi-field interdiscipline, and relates to a plurality of disciplines such as probability theory, statistics, approximation theory, convex analysis, and algorithm complexity theory. ML specializes in studying how a computer simulates or implements a human learning behavior to obtain new knowledge or skills, and reorganize an existing knowledge structure, so as to keep improving its performance. ML is the core of AI, is a basic way to make the computer intelligent, and is applied to various fields of AI. ML and deep learning generally include technologies such as an artificial neural network, a belief network, reinforcement learning, transfer learning, inductive learning, and learning from demonstrations.

A design idea of the embodiments of the present disclosure is generally described below.

With rapid development of network technologies and promotion of multimedia applications, various videos constantly emerge. To improve response efficiency and accuracy of downstream services (such as: video recommendation, video search, and video distribution) of the multimedia applications, most downstream services are implemented based on video tags. A video is usually tagged with various rich tags (such as: a drama name tag, a topic tag, and a category tag) through a tag system, and a tag result of the video directly affects the accuracy of the downstream services.

In some methods, tags generated for videos mainly include a drama name tag, a topic tag, a category tag, and the like. However, these tags mainly reflect main content of the videos, and cannot highlight key persons in the videos. In this way, for a target person that an object likes, downstream services need to search repeatedly to obtain a matched video, thereby causing a load on a backend server of a multimedia application, reducing response efficiency, and reducing user experience of the object on the multimedia application.

Therefore, generating a personal name tag for the video becomes a problem to be urgently solved in the downstream services. The disclosed video tagging process can be used to automatically tag massive videos hosted by one or more online services, such as short and/or long video websites that allow users to upload and share user generated contents in video form. The amount of videos being tagged in one work job (e.g., completed in one hour or in one day) can be in the magnitude of millions, billions, or trillions. The total volume of videos being tagged in one work job can be in the magnitude of terabytes, petabytes, exabytes, zettabytes, etc.

Methods for tagging videos in some tag systems include: a retrieval-based tag recall method and a classification-based tag recall method. According to the retrieval-based tag recall method, a corresponding video is added to a retrieval library when a tag is entered into the library. In this way, during actual use, a corresponding tag is obtained by a method of retrieving a similar video, so as to recall the tag. According to the classification-based tag recall method, a closed-set tag classifier is learned to perform multi-tag classification on video content, so as to recall a tag. However, these two tagging methods are mostly general tag recall technologies. Because there are many personal names in a video, there are usually several key persons (that is, protagonists), and different objects like different persons, an accurate personal name tag cannot be tagged for the video by using a general tag recall technology. In this way, a downstream service needs to search repeatedly to obtain the video of a person that a target object likes, thereby causing a load on a backend server of a multimedia application, reducing response efficiency, and reducing user experience of the object on the multimedia application.

Embodiments of the present disclosure provide a video tag generation method and apparatus, an electronic device, and a storage medium, which can specifically tag a video with an accurate personal name tag. According to the method, a face recognition technology and a fuzzy matching technology are performed on information in a plurality of modalities (such as: a picture and text) of the video to extract personal names from the multimodal information, and sorting and screening are performed according to importance of the personal names appearing in video frames by using a sorting and screening technology, so as to obtain a personal name tag of a key person in the video. On one hand, rich personal name information in video auxiliary information such as a title, a cover picture, a subtitle, and a comment of the video can be fully used to provide important basis for screening a personal name of a key person, thereby improving accuracy of a personal name tag; on the other hand, during screening, an attention mechanism is used, so that a mutual relationship between personal names appearing in the video frames can be learned, an incorrect personal name tag is well filtered out, and a correct personal name tag is screened, so that a recall rate of the personal name tag is improved, thereby improving accuracy and efficiency of a downstream service response.

The embodiments of the present disclosure provide a method for tagging a video with a personal name tag, which is applicable to a short video and a long video.

An implementation process of generating a personal name tag provided in this embodiment of the present disclosure is described below by taking the short video as an example.

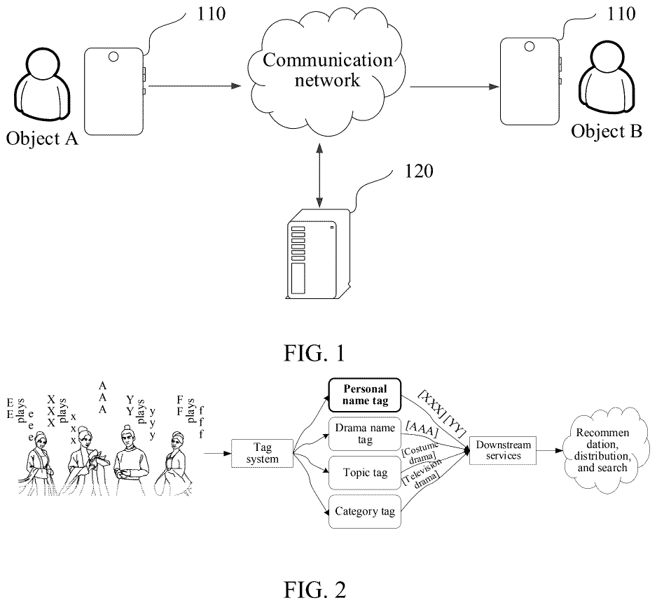

Refer to FIG. 1, which is a schematic diagram of an application scenario according to an embodiment of the present disclosure. The application scenario includes two terminal devices 110 and a server 120.

In this embodiment of the present disclosure, the terminal device 110 includes, but is not limited to, devices such as a mobile phone, a tablet computer, a notebook computer, and a desktop computer. A multimedia application is installed on the terminal device 110. Through the multimedia application, the short video can be watched and edited, and the short video can be sent to the server 120. The server 120 is a backend server of the multimedia application, is configured to tag a short video, and is responsible for tag-based downstream services such as video distribution, video search, and video recommendation. The server 120 may be an independent physical server, or may alternatively be a server cluster or a distributed system composed of a plurality of physical servers, and may alternatively be a cloud server providing basic cloud computing services such as a cloud service, a cloud database, cloud computing, a cloud function, cloud storage, a network service, cloud communication, a middleware service, a domain name service, a security service, a content delivery network (CDN), big data, and an artificial intelligence platform.

In this embodiment of the present disclosure, the terminal device 110 may communicate with the server 120 through a communication network.

In some implementations, the communication network is a wired network or a wireless network.

A short video tag generation method in this embodiment of the present disclosure may be performed by the server 120 in FIG. 1. Specifically, an object A edits the short video through the terminal device 110, and uploads an edited short video to the server 120. The server 120 extracts a plurality of key frames from the short video, performs face recognition, obtains a candidate personal name set based on a face recognition result, extracts an auxiliary personal name set from video auxiliary information such as a cover picture and a title of the short video, and screens the candidate personal name set according to the auxiliary personal name set, to obtain a personal name tag of the short video. The short video is presented to an object B through the terminal device 110 based on the personal name tag of the short video.

FIG. 1 is merely an example for description. Actually, quantities of terminal devices and servers are not limited, and are not specifically limited in this embodiment of the present disclosure.

In this embodiment of the present disclosure, when there are a plurality of servers, the plurality of servers may form a blockchain, and the servers are nodes on the blockchain. According to the short video tag generation method disclosed in this embodiment of the present disclosure, related multimedia information such as a cover picture, a title, a subtitle, a key frame, and a comment may be stored on the blockchain.

In some application scenarios, the foregoing multimedia information may be stored by using a cloud storage technology. Cloud storage is a new concept extended and developed from a concept of cloud computing. A distributed cloud storage system (referred to as a storage system for short below) is a storage system integrating a large number of different types of storage devices (the storage devices are also referred to as storage nodes) in a network through functions such as a cluster application, a grid technology, and a distributed file storage system through application software or application interfaces to enable the storage devices to work together to provide data storage and service access functions to the outside.

The short video including faces captured in this embodiment of the present disclosure is obtained through a legal channel, and is configured for adding a personal name tag to the short video after being authorized by a person himself or herself, a film maker, or the like, cannot be arbitrarily applied to other services, and does not affect a personal image of a person in the short video.

Implementations of the present disclosure are merely shown for ease of understanding the spirit and principle of the present disclosure, and are not intended to limit the application scenario.

The short video tag generation method provided in this embodiment of the present disclosure may be used in a tag system, and is configured for enriching tags in an existing tag system, which achieves adding the personal name tag to the short video, and provides important information for the downstream services (such as: video distribution, video search, and video recommendation) based on a highly accurate and highly recalled video tag.

Refer to FIG. 2, which is a schematic diagram of a tag application process of a short video. A tag system tags the short video with a drama name tag [AAA], a topic tag [a costume drama], a category tag [a television drama], and the like corresponding to content of the short video by using an existing tag method, and tags the short video with a personal name tag [XXX], [YY] corresponding content of the short video by using the method according to this embodiment of the present disclosure. Downstream services perform tasks such as recommendation, search, and distribution of the short videos based on any tag or a plurality of tags.

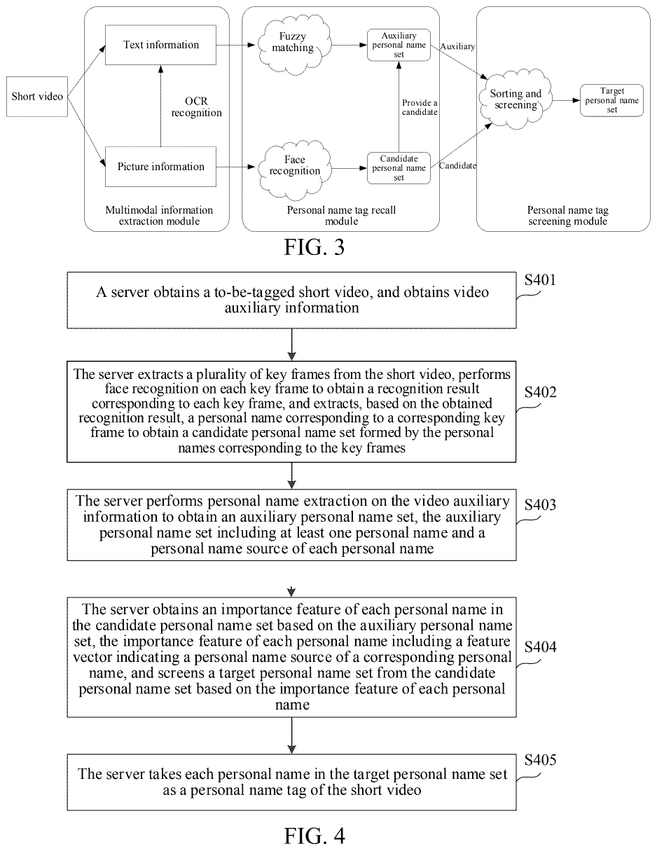

Refer to FIG. 3, which is an overall architectural diagram of a short video tag generation method according to an embodiment of the present disclosure, mainly involving a multimodal information extraction module, a personal name tag recall module, and a personal name tag screening module.

The multimodal information extraction module is configured to perform preliminary processing on an original short video, including: extracting video auxiliary information of the short video, including text information (for example: text extracted from a title, a subtitle, and a comment) and picture information (for example: a cover picture and a poster); performing OCR on each piece of extracted picture information to obtain text in each piece of picture information; and extracting a plurality of key frames from the short video.

The personal name tag recall module includes a face recognition unit and a fuzzy matching unit. The face recognition unit is configured to recognize, by using a face recognition technology, a person in each piece of picture information included in the video auxiliary information to obtain a personal name of a face in each piece of picture information, and recognize, by using the face recognition technology, a person in the plurality of extracted key frames to obtain a personal name of a face in the key frames. The fuzzy matching unit is configured to perform matching processing on a personal name in each piece of text information included in the video auxiliary information by using the personal name obtained from the key frames to obtain the personal name included in each piece of text information.

The personal name tag screening module is configured to perform uniform sorting on output of the personal name tag recall module, take the personal name corresponding to the face in the plurality of key frames as a candidate tag, take personal name in the video auxiliary information such as a title and a cover picture as an auxiliary tag, and calculate a key person evaluation value corresponding to the personal name corresponding to the face in the plurality of key frames with reference to a category tag of the short video, so as to screen a personal name of a key person based on each key person evaluation value, and take the screened personal name of the key person as a personal name tag of the short video.

Based on the overall architecture diagram shown in FIG. 3, a specific implementation process of a short video tag generation method according to an embodiment of the present disclosure is shown in FIG. 4, and mainly includes the following operations:

S401: A server obtains a to-be-tagged short video, and obtains video auxiliary information.

In some examples, the video auxiliary information includes at least one of text information and picture information. The text information includes, but is not limited to, text extracted from a title, a subtitle, and a comment of the short video. The picture information includes, but is not limited to, a cover picture, a poster, and an extracted key frame.

In some examples, the text information may be original text associated with the short video (for example, text extracted from a title of the short video), and may alternatively be a text part extracted from the picture information (for example, text extracted from the cover picture).

In some examples, the video auxiliary information includes at least one piece of text information, and different pieces of text information are from different information sources. For example, assuming that one piece of text information included in the video auxiliary information is text extracted from a title of the short video, the information source of the text information is the title.

In some examples, the video auxiliary information includes at least one piece of picture information, and different pieces of picture information are from different information sources. For example, assuming that one piece of picture information included in the video auxiliary information is a cover picture, the information source of the picture information is the cover picture.

S402: The server extracts a plurality of key frames from the short video, performs face recognition on each key frame to obtain a recognition result corresponding to each key frame, and extracts, based on each recognition result, a personal name corresponding to a corresponding key frame to obtain a candidate personal name set including the personal names corresponding to the key frames.

In some examples, the plurality of key frames may be extracted from the short video according to a preset interval, and the quantity of extracted frames is positively correlated with total duration of the short video. That is, longer total duration of the short video indicates more extracted key frames. The quantity of frames extracted each time may be one frame, or may be a plurality of consecutive frames.

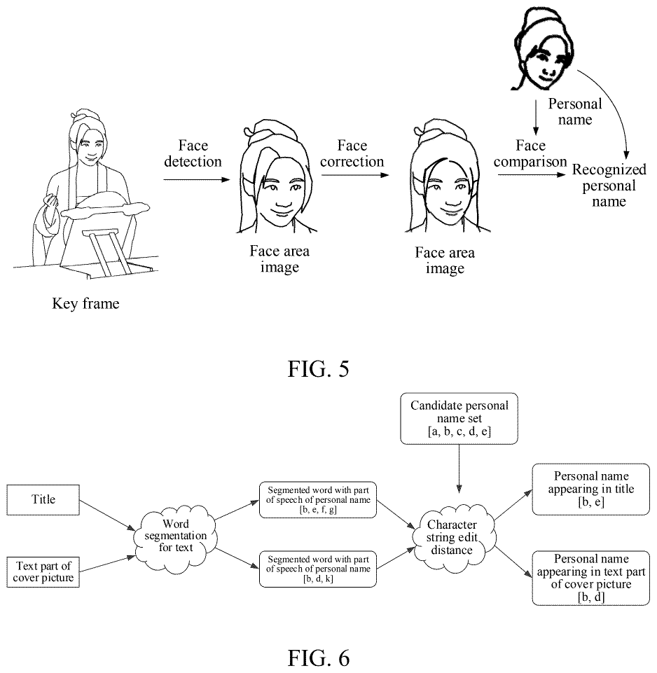

Face recognition is performed on each extracted key frame. Taking one key frame as an example, as shown in FIG. 5, during a specific implementation, a face detection algorithm is used first to obtain a face area image of the key frame. Considering different orientations of different persons in the key frames, in this way, the face area image may be a side of a face. To improve accuracy of face recognition, a frontal face is usually configured for recognition. Therefore, for a detected face area image, a feature point of the face in the face area image is extracted through a key point detection algorithm, an angle of the face is calculated based on the extracted face feature point, and face correction is performed based on the angle to obtain a frontal face area image. Then, feature extraction is performed on the face area image, an extracted face feature is compared with a face feature of a preset face in a preset face library to obtain a face similarity, and a personal name corresponding to the preset face with highest face similarity is taken as a personal name corresponding to the face area image in the key frame.

Currently, a face recognition algorithm is relatively mature. Therefore, the face in the key frame can be accurately recognized, ensuring accuracy of personal name extraction.

In some examples, a face detection model in face recognition may use a retina-face model, and a face feature extraction process may use a resnet34 model.

In some examples, the candidate personal name set may be obtained based on a personal name corresponding to at least one face in each key frame.

In this embodiment of the present disclosure, when face recognition is performed on each key frame, confidence of a recognized face and a frame sequence number of the key frame in which the recognized face is located may further be obtained in addition to recognizing the face in the key frame, as shown in Table 1.

TABLE 1
Face information corresponding to each candidate personal name

| Candidate personal name | Frame sequence number | Confidence |
|---|---|---|
| A | Key frame 1, key frame 4, key | 0.9 |
| | frame 6, . . . | |
| B | Key frame 1 and key frame 3 | 0.87 |
| C | Key frame 2 | 0.92 |
| D | Key frame 5 | 0.8 |
| . . . | . . . | . . . |

One or more faces may be recognized from one key frame, and one face may appear in one or more key frames. Therefore, the personal name corresponding to a same face may correspond to a plurality of frame sequence number, and different personal names may correspond to a same frame sequence number. The confidence of the face recognition may represent accuracy of personal name extraction, and a value of the confidence ranges from 0 to 1.

In this embodiment of the present disclosure, a personal name of a person in the plurality of extracted key frames can be accurately recognized through a face recognition technology. However, there are many complex personal names recognized in the plurality of key frames, and excessive personal name tags are tagged, leading to tedious information and affecting applications of downstream services. Therefore, a candidate personal name set needs to be screened to extract a personal name of a key person in the short video, thereby improving purity of the personal name tags.

S403: The server performs personal name extraction on the video auxiliary information to obtain the auxiliary personal name set, the auxiliary personal name set including at least one personal name and a personal name source of each personal name.

The tag system not only needs to tag the short video, but also needs to tag a tag identifier (such as an ID). Different from a face recognition process of each key frame, each candidate personal name can be tagged with the tag identifier through the frame sequence number, and an auxiliary personal name extracted from the video auxiliary information cannot be tagged with the tag identifier. However, personal names appearing in the video auxiliary information such as the cover picture and the title play an important role in screening the personal name of the key person. Therefore, the personal name in the video auxiliary information may be taken as an auxiliary personal name tag in a fuzzy matching mode to perform tag screening on the candidate personal name set obtained through face recognition, that is, whether each personal name in the candidate personal name set appears in the video auxiliary information is determined, and then the personal name source of the corresponding personal name is determined according to an information source of text information and an information source of picture information in which the corresponding personal name appears.

FIG. 6 shows a fuzzy matching process of a personal name tag, which is mainly divided into two parts: word segmentation for text and calculation for character string edit distance.

The word segmentation part for the text is configured for extracting a personal name in video auxiliary information. In some examples, text such as text extracted from a title of a short video and a text part extracted from a cover picture is inputted into a QQSeg word segmentation tool to obtain a word segmentation result of the text and a part of speech of each segmented word, and a segmented word with the part of speech of personal name is selected. For example, in FIG. 6, the title includes the segmented words with the part of speech of personal name [b, e, f, g], and the text part of the cover picture includes the segmented words with the part of speech of personal name [b, d, k].

The calculation part for the character string edit distance is configured for calculating, for each personal name in the candidate personal name set, an edit distance between the personal name and a personal name of the title and the text part of the cover picture, so as to determine whether the personal name appears in the title and the cover picture, thereby determining whether the personal name source of the personal name includes the title and the text part of the cover picture. For example, in FIG. 6, personal names [b, e] in the candidate personal name set appear in the title of the short video, and personal names [b, d] in the candidate personal name set appear in the cover picture of the short video. In this way, an auxiliary personal name set may be obtained, and the personal names included in the auxiliary personal name set are: b, e, and d, where a personal name source of the personal name b is the title and the cover picture, a personal name source of the personal name e is the title, and a personal name source of the personal name d is the cover picture.

In this embodiment of the present disclosure, the personal names may be extracted from the video auxiliary information to obtain the auxiliary personal name set. Because the video auxiliary information includes information in a plurality of modalities such as a picture and text, and for information in different modalities, the personal names are extracted in different modes. Therefore, the auxiliary personal name set may be generated in a plurality of modes.

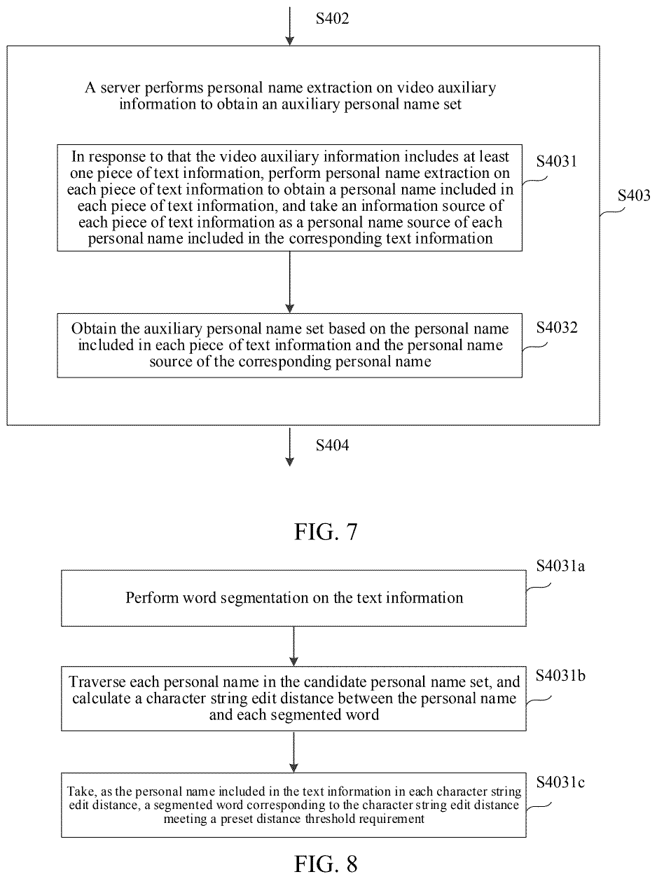

Taking an example in which the video auxiliary information is text information, referring to FIG. 7, a process of generating the auxiliary personal name set mainly includes the following operations:

S4031: In response to that the video auxiliary information includes at least one piece of text information, perform personal name extraction on each piece of text information to obtain a personal name included in each piece of text information, and take an information source of each piece of text information as a personal name source of each personal name included in the corresponding text information.

During tagging a short video with the personal name tag, whether the personal name appears in a title, a comment, and a subtitle of the short video provides important basis for importance of the personal name. Therefore, the personal name in the text information needs to be recognized. Meanwhile, for each piece of text information, the information source of the text information is taken as the personal name source of each personal name recognized from the text information.

Text extracted from the title, the comment, the subtitle, and the like of the short video is recorded as original text associated with the short video, that is, the information is originally described by the text, and text recognition may be directly performed.

In some examples, in addition to a person picture, the picture information such as the cover picture and the poster of the short video may further include some text descriptions, and these text descriptions provide the important basis for the importance of the personal name. Therefore, a text part in the picture information needs to be recognized by using an OCR technology, and the recognized text part is taken as the text information of the short video.

In some examples, the information source of each piece of text information included in the video auxiliary information includes, but is not limited to: the title, the comment, the subtitle, a text part of the cover picture, a text part of the poster, and the like.

S4032: Obtain an auxiliary personal name set based on the personal name included in each piece of text information and the personal name source of the corresponding personal name.

Referring to FIG. 8, a main process of performing personal name extraction on a piece of text information includes the following operations:

S4031a: Perform word segmentation on the text information.

S4031b: Traverse each personal name in the candidate personal name set, and calculate a character string edit distance between the personal name and each segmented word.

Considering that not all text is related to personal names, for each segmented word segmented from the text information, a segmented word with a part of speech of personal name in each segmented word may be obtained through further processing in fuzzy matching.

It is considered that a personal name of a same person may be represented in a plurality of forms (for example: an abbreviation, a full name, an alias name). For example, for a personal name ‘aaa’ of a person, a full name ‘bbbaaaa’, an alias name ‘cc’, or a name with a punctuation mark ‘bbb.aaa’ may appear in the text information. In this way, if it is directly determined whether each personal name is completely the same as a character string of each segmented word, the personal name in the text information possibly cannot be accurately extracted. Therefore, in some examples, in a fuzzy matching process, a character string edit distance between each personal name in the candidate personal name set and the segmented word may be calculated to screen the segmented word with the part of speech of personal name from each segmented word, that is, whether each personal name appears in the text information is determined.

A calculation formula of the character string edit distance is as follows:

$$l e {v}_{A , B} ( i , j ) = \{ \begin{matrix}i & , j = 0 \\ j & , i = 0 \\ min \{ \begin{matrix}{lev}_{x , y} ( i , j - 1 ) + 1 \\ {lev}_{x , y} ( i - 1 , j ) + 1 \\ {lev}_{x , y} ( i - 1 , j - 1 ) + {1}_{( {x}_{i} \neq {y}_{j} )}\end{matrix} & , otherwise\end{matrix} \qquad Formula 1$$

where A represents a personal name, B represents a segmented word, x represents a character length of the personal name, and y represents a character length of the segmented word.

In this embodiment of the present disclosure, the character string edit distance is configured for representing matching degree between two character strings. During a specific implementation, for each personal name, a character length of the personal name and a character length of any segmented word are determined; if the character lengths of the two character strings are different, a partial edit distance between a short character string and a substring of a long character string is calculated; and when the partial edit distance is less than a preset distance threshold, it is determined that the short character string matches the substring of the long character string, that is, the short character string appears in the long character string. If character lengths of the two character strings are the same, a global edit distance between the two character strings is calculated. When the global edit distance is less than a preset distance threshold, it is determined that the two character strings match.

For example, a partial edit distance between ‘bbb’ and ‘bbbaaaa’ is 0; and a partial edit distance between ‘mn’ and ‘mms’ is 50.

The preset distance threshold in this embodiment of the present disclosure may be set according to an actual requirement. For example, in some implementations, the preset distance threshold is set to 80.

S4031c: Take, as the personal name included in the text information in each character string edit distance, a segmented word corresponding to the character string edit distance meeting a preset distance threshold requirement.

In some examples, for each personal name in the candidate personal name set, the personal name may appear in the title, or may appear in a text part of the cover picture, that is, the personal name may match one or more segmented words with character string edit distances less than the preset distance threshold. Matched segmented words in the text information such as the title and the text part of the cover picture are taken as the personal names in the auxiliary personal name set, and the personal name source of the corresponding personal name is determined according to the information source of the text information and the information source of the picture information in which each personal name appears.

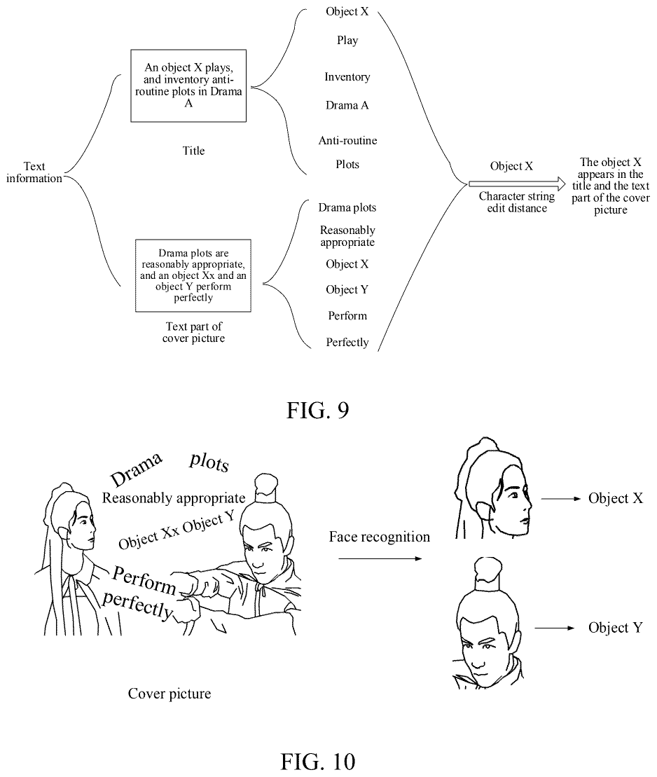

For example, FIG. 9 shows a schematic diagram of a process of extracting a personal name from text information. It is assumed that a candidate personal name set includes an object X, and text information includes text “an object X plays, and inventory anti-routine plots in Drama A” extracted from a title of a short video, and a text part including a cover picture: “Drama plots are reasonably appropriate, and an object Xx and an object Y perform perfectly”. A result obtained by performing word segmentation on the words extracted from the title is: object X, play, inventory, Drama A, anti-routine, and plots; and a result obtained by performing word segmentation on the text part of the cover picture is: Drama plots, reasonably appropriate, object X, object Y, perform, and perfectly. It is determined that the object X appears in the title and the text part of the cover picture of the short video by calculating a character string edit distance between the object X and each segmented word. Therefore, the object X is taken as a personal name in the auxiliary personal name set, and the title and the text part of the cover picture are taken as personal name sources of the object X.

In some examples, the picture information (for example, the cover picture and the poster of the short video) in the video auxiliary information may alternatively include a picture of a person in the short video. Therefore, face recognition may be performed on each piece of picture information included in the video auxiliary information, a personal name corresponding to a recognized face included in each piece of picture information is taken as a personal name in the auxiliary personal name set, and an information source of corresponding picture information is taken as a personal name source of the personal name corresponding to each face included in the corresponding picture information.

Taking an example in which the picture information is a cover picture of a short video, FIG. 10 is a schematic diagram of a process of extracting a personal name from picture information. After face detection is performed on the cover picture, two face area images are obtained. The two face area images are corrected to obtain corresponding frontal face area images. Further, feature extraction is performed on the two frontal face area images, face recognition is performed based on extracted face features to determine a personal name corresponding to the face in each frontal face area image as follows: an object X and an object Y. The recognized object X and object Y are directly taken as personal names in the auxiliary personal name set, and the cover picture is taken as a personal name source of the object X and a personal name source of the object Y.

S404: The server obtains an importance feature of each personal name in the candidate personal name set based on the auxiliary personal name set, the importance feature of each personal name including a feature vector indicating a personal name source of a corresponding personal name, and screens a target personal name set from the candidate personal name set based on the importance feature of each personal name.

In this embodiment of the present disclosure, in the plurality of key frames extracted from the short video, roles of characters are relatively rich. Therefore, personal names in the candidate personal name set may relatively comprehensively cover persons in the short video, but may include some persons that are not very critical (for example, costars). The personal names in the auxiliary personal name set extracted from video auxiliary information such as a cover picture, a text part of the cover picture, and a title are usually personal names of key persons with relatively high importance in the short video. Therefore, the personal names in the candidate personal name set may be taken as candidates for short video tags, the personal names in the auxiliary personal name set may be taken as auxiliary short video tags, and the personal names in each candidate personal name set are sorted according to importance. Therefore, a target personal name set of the key persons is screened, and the personal names in the screened target personal name set are taken as personal name tags of the short video.

A process of screening the target personal name set may be performed through a target screening model established based on a deep learning algorithm.

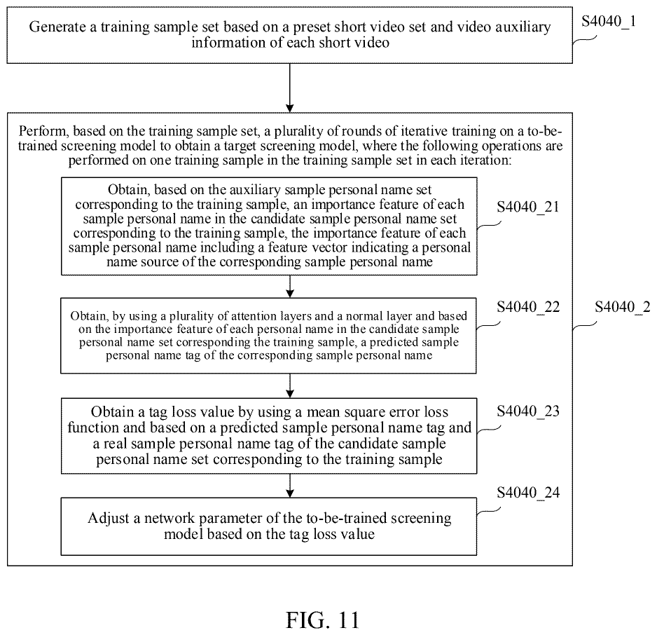

In some examples, for a process of training the target screening model, refer to FIG. 11, which mainly includes the following operations:

S4040_1: Generate a training sample set based on a preset short video set and video auxiliary information of each short video.

Each training sample includes a candidate sample personal name set, an auxiliary sample personal name set, and a real sample personal name tag corresponding to one short video. The candidate sample personal name set includes a plurality of sample personal names, and the auxiliary sample personal name set includes at least one sample personal name and a personal name source of each sample personal name.

During a specific implementation, a preset short video set (for example, 100,000 short videos) and video auxiliary information of each short video are obtained from a multimedia application. For each short video, a candidate sample personal name set is extracted from a plurality of key frames of the short video, an auxiliary sample personal name set is extracted from video auxiliary information of the short video, and each sample personal name in the candidate personal name set of the short video is tagged with a real sample personal name tag to obtain a training sample.

Taking a sample personal name in a candidate sample personal name set as an example, when the sample personal name is a name of a key person (for example, a star) in the short video, the real sample personal name tag corresponding to the sample personal name is 1, and when the sample personal name is not a name of the key person (for example, an extra) in the short video, the real sample personal name tag corresponding to the sample personal name is 0.

In some examples, a to-be-trained screening model may be built by multihead-attention layers, and a normal layer and an activation function (ReLU) are correspondingly inserted between the multihead-attention layers, and are configured for extracting a key person feature of each sample personal name in the candidate sample personal name set. Finally, the key person feature of each sample personal name is mapped to a range of (0, 1) by using a Fully Connected (FC) layer and a softmax function to obtain a key person evaluation value.

A multihead-attention mechanism-based target screening model in this embodiment of the present disclosure can comprehensively consider the personal name source of each personal name, fully learn a mutual relationship between the personal names in the candidate personal name set and the personal names in the auxiliary personal name set, and well filter out incorrect personal name tags, thereby improving filtering effectiveness, and improving accuracy of personal name tag recall.

A short video usually includes personal names corresponding to a plurality of faces. To improve stability of a sorting and screening model, a quantity of personal names in the candidate personal name set in each training sample may be limited.

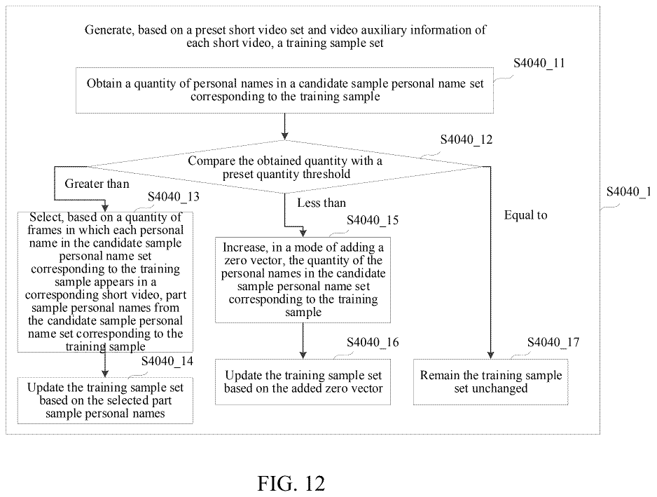

Taking one training sample in the training sample set as an example, for a process of limiting the quantity of the personal names in the candidate personal name set, refer to FIG. 12, which mainly includes the following operations.

S4040_11: Obtain a quantity of personal names in a candidate sample personal name set corresponding to the training sample.

S4040_12: Compare the obtained quantity with a preset quantity threshold. Perform S4040_13 if the quantity is greater than the preset quantity threshold. Perform S4040_15 if the quantity is less than the preset quantity threshold. Perform S4040_17 if the quantity is equal to the preset quantity threshold.

S4040_13: Select, based on a quantity of frames in which each personal name in the candidate sample personal name set corresponding to the training sample appears in a corresponding short video, part sample personal names from the candidate sample personal name set corresponding to the training sample.

S4040_14: Update the training sample set based on the selected part sample personal names.

S4040_15: Increase, in a mode of adding a zero vector, the quantity of the personal names in the candidate sample personal name set corresponding to the training sample.

S4040_16: Update the training sample set based on the added zero vector.

S4040_17: Remain the training sample set unchanged.

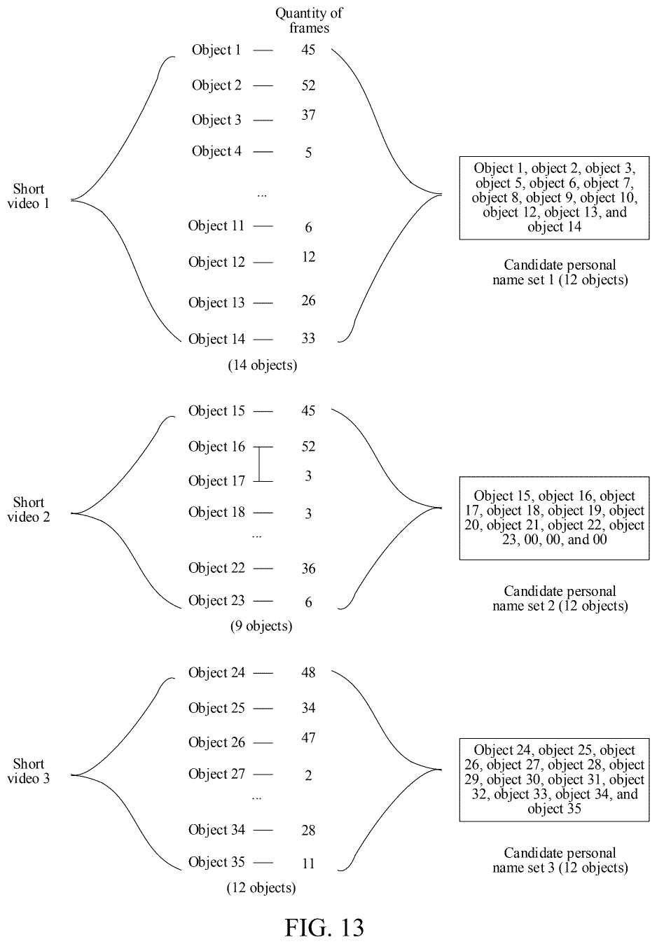

For example, as shown in FIG. 13, assuming that the preset quantity threshold is 12, if the quantity of the personal names corresponding to a short video 1 is greater than 12, the quantity of frames in which each personal name appears in the short video 1 is counted, and 12 personal names having a largest quantity of frames are reserved as personal names in a candidate sample personal name set corresponding to a first training sample. If quantity of the personal names corresponding to a short video 2 is less than 12, three zero vectors are added, so that a candidate sample personal name set of a second training sample includes 12 candidate personal names. If the quantity of the personal names corresponding to a short video 3 is equal to 12, the 12 personal names are directly taken as personal names in a candidate sample personal name set of a third training sample.

S4040_2: Perform, based on the training sample set, a plurality of rounds of iterative training on a to-be-trained screening model to obtain the target screening model.

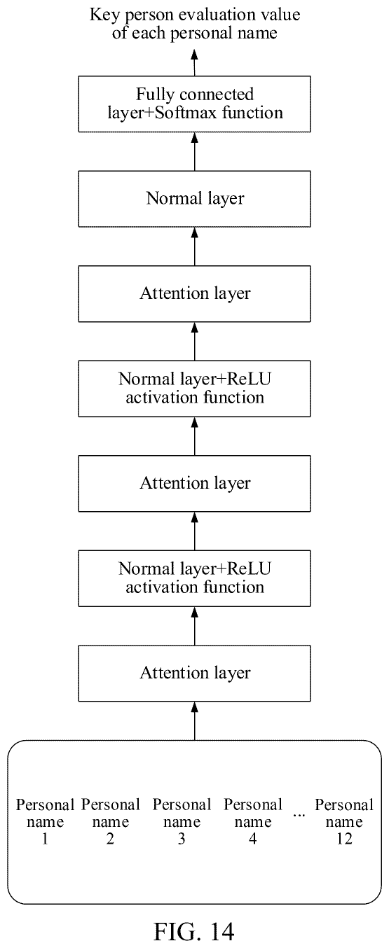

As shown in FIG. 14, which is a schematic diagram of a network structure of a screening model. The model is built by using three attention layers, and a candidate sample personal name set corresponding to each training sample includes 12 personal names.

Based on the network structure of the to-be-trained screening model shown in FIG. 14, the plurality of rounds of iterative training is performed by using the foregoing training sample set to obtain a converged target screening model, where the following operations are performed on one training sample in the training sample set in each iteration:

S4040_21: Obtain, based on the auxiliary sample personal name set corresponding to the training sample, an importance feature of each sample personal name in the candidate sample personal name set corresponding to the training sample. The importance feature of each sample personal name includes a feature vector indicating a personal name source of the corresponding sample personal name.

In some examples, sample persons in the auxiliary sample personal name set are usually names of key persons. For a short video, these names are of relatively high importance. Therefore, an importance feature of each sample personal name in the candidate sample personal name set corresponding to the short video may be extracted based on the auxiliary sample personal name set corresponding to the short video.

S4040_22: Obtain, by using a plurality of attention layers and a normal layer and based on the importance feature of each personal name in the candidate sample personal name set corresponding the training sample, a predicted sample personal name tag of the corresponding sample personal name.

The target screening model performs personal name information extraction on input data by using a neural network. To reduce complexity of the model, in some examples, a feature vector of each sample personal name that indicates the personal name source of the corresponding sample personal name may be represented by using a multi-dimensional binary vector, to obtain an importance feature of the corresponding personal name.

S4040_23: Obtain a tag loss value by using a mean square error loss function and based on the predicted sample personal name tag and the real sample personal name tag of the candidate sample personal name set corresponding to the training sample.

In some examples, supervised training is performed on the to-be-trained screening model by using a mean square error (MSE) loss function to obtain a tag loss value of each sample personal name. An MSE loss function formula is expressed as follows:

$$loss ( {z}_{i} , {z}_{i}^{′} ) = {( {z}_{i} - {z}_{i}^{′} )}^{2} \qquad Formula 2$$

where zᵢ represents a predicted sample personal name tag of a sample personal name, that is, a key person evaluation value in an actual application, and z′ᵢ represents a real sample personal name tag of a sample personal name.

S4040_24: Adjust a network parameter of the to-be-trained screening model based on the tag loss value.

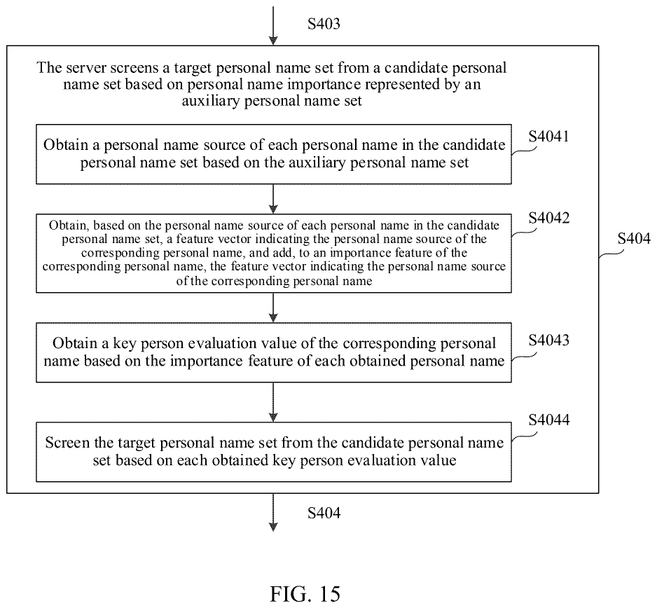

In an actual application, a personal name tag of the short video is screened from the candidate personal name set based on a trained target screening model. For a specific screening process, refer to FIG. 15, which mainly includes the following operations:

S4041: Obtain a personal name source of each personal name in the candidate personal name set based on the auxiliary personal name set.

Taking one personal name in the candidate personal name set as an example, matching is performed on the personal name and each personal name in the auxiliary personal name set, and the personal name source of the personal name matching the personal name in the auxiliary personal name set is taken as the personal name source of the personal name. When all or some characters of the personal name are the same as a character string of any personal name in the auxiliary personal name set, it is considered that the two personal names match.

S4042: Obtain, based on the personal name source of each personal name in the candidate personal name set, a feature vector indicating the personal name source of the corresponding personal name, and add, to an importance feature of the corresponding personal name, the feature vector indicating the personal name source of the corresponding personal name. The feature vector indicating the personal name source of the corresponding personal name includes feature values corresponding to a plurality of personal name sources, a feature value corresponding to each personal name source included in the personal name source of the corresponding personal name is set to a first value (for example, 1), and a feature value corresponding to each personal name source not included in the personal name source of the corresponding personal name is set to a second value (for example, 0).

Taking an example in which the text information included in the video auxiliary information is text extracted from a title of the short video and a text part of a cover picture of the short video, and the picture information included in the video auxiliary information is the cover picture, for each personal name in the candidate personal name set, a three-dimensional binary vector is configured for representing a feature vector indicating a face source of the personal name.

Taking one personal name as an example, the feature vector indicating the face source of the personal name is [0, 1, 1], where 0 indicates that the personal name does not appear in the title of the short video, the personal name source of the personal name does not include the title, the first 1 indicates that the personal name appears in a face part of the cover picture of the short video, the personal name source of the personal name includes the cover picture, the second 1 indicates that the personal name appears in the text part of the cover picture of the short video, and the personal name source of the personal name includes the text part of the cover picture.

In this embodiment of the present disclosure, when face recognition is performed on the plurality of extracted key frames to extract a candidate personal name set, a face recognition result further includes confidence of a recognized face, as shown in Table 1. The confidence of the face may represent accuracy of personal name extraction, and the accuracy of personal name extraction directly affects accuracy of the personal name tag. Therefore, the importance feature corresponding to each personal name further includes the confidence of the face.

In some examples, the confidence of the face recognized in the corresponding key frame is obtained based on the recognition result of each key frame, and the confidence of the face corresponding to each personal name is added to the importance feature of the corresponding personal name.

In some embodiments, the confidence of the face is represented by using a 9-dimensional binary vector. During a specific implementation, a value interval of the confidence of each face recognition ranges from 0 to 1, and the value interval of the confidence [0, 1] is evenly divided into 10 segments from low to high: [0, 0.1), [0.1, 0.2), [0.2, 0.3), [0.3, 0.4), [0.4, 0.5), [0.5, 0.6), [0.6, 0.7), [0.7, 0.8), [0.8, 0.9), [0.9, 1], where each interval segment occupies one dimension.

Taking one personal name as an example, the confidence of the face corresponding to the personal name being 0.85 is a ninth segment, a value of an eighth dimension is 1, and remaining dimensions are 0, that is, [0, 0, 0, 0, 0, 0, 0, 0, 1, 0].

In this embodiment of the present disclosure, when face recognition is performed on the plurality of extracted key frames to extract the candidate personal name set, the face recognition result further includes a frame sequence number of a key frame in which the recognized face is located, as shown in Table 1. The frame sequence number of the key frame may represent a frequency at which the personal name appears in the short video, and a personal name with a higher frequency of appearance is more likely to be a personal name of a key person in the short video. Therefore, the importance feature corresponding to each personal name further includes the frame sequence number of the key frame.

In some examples, based on the recognition result of each key frame, the frame sequence number of the key frame in which the face corresponding to each candidate personal name is located is obtained, and the frame sequence number corresponding to each candidate personal name is added to the importance feature of a corresponding candidate personal name.

Taking an example in which 60 key frames are extracted, a 60-dimensional binary vector may be configured for representing frame sequence numbers of the key frames. Each key frame corresponds to one dimension. When a value of a vector in the dimension is 1, it indicates that the personal name appears in the key frame corresponding to the frame sequence number in the dimension. When a value of a vector in the dimension is 0, it indicates that the candidate personal name does not appear in the key frame corresponding to the frame sequence number in the dimension.

In an actual application, a famous person usually has a particular character form. For example, an idiomatic actor usually does not become a key person in a comedy. Therefore, in some embodiments, the importance feature of each personal name further includes a video category of the short video. Specifically, after the short video is obtained, the video category of the short video is recognized through a trained classification model in a tag system, and the video category is added to the importance feature of each personal name.

In some examples, the video category may be represented by using a multi-dimensional binary vector.

For example, assuming that there are 31 video categories in total, including movies, television dramas, animations, variety shows, sports, news, and the like, the video categories are represented by using a 31-dimensional binary vector, and each dimension represents one video category. For example, a 31-dimensional binary vector [1, 0, 0, . . . , 0] (30 dimensions of 0 in total) indicates that the video category of the short video is movie.

S4043: A key person evaluation value of the corresponding personal name is obtained based on the importance feature of each obtained personal name.

The importance feature of each personal name is inputted into the trained target screening model, and the target screening model outputs the key person evaluation value of the corresponding personal name. A larger key person evaluation value indicates a larger possibility that the candidate personal name is a personal name tag of the short video.

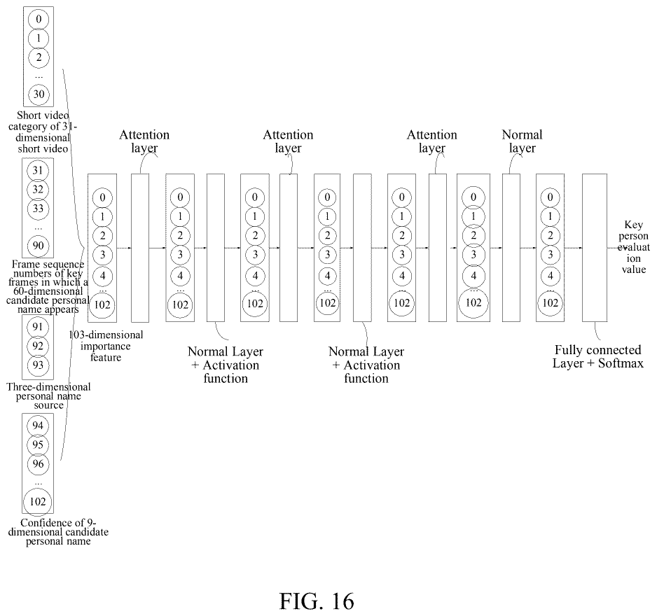

Taking a process of determining a key person evaluation value of one personal name as an example, as shown in FIG. 16, an importance feature of each personal name is represented by using a 103-dimension binary vector. Dimensions 0-30 represent a video category of the short video corresponding to the personal name, dimensions 31-90 represent frame sequence numbers of the extracted 60 key frames in which the personal name appears, and dimensions 91-93 represent a personal name source of the personal name. Whether the personal name appears in a title, a text part of a cover picture, and a face part of the cover picture of the short video may be determined according to the personal name source of the personal name, and dimensions 94-102 represent confidence of a face corresponding to the personal name. The 103-dimensional importance feature are inputted to the target screening model, and the key person evaluation value corresponding to the personal name is obtained through three layers of attention layers, normal layers, and activation functions.

S4044: Screen the target personal name set from the candidate personal name set based on each obtained key person evaluation value.

In some examples, the key person evaluation values of the personal names are sorted, and personal names corresponding to first K (K≥1) key person evaluation values are outputted as target personal names to obtain the target personal name set.

In some other examples, an evaluation threshold may be preset according to an actual requirement, and a current key person evaluation value is compared with the preset evaluation threshold. If the current key person evaluation value is greater than or equal to the preset evaluation threshold, a personal name corresponding to the key person evaluation value is outputted as a target personal name, and otherwise, the personal name is not outputted. The target personal name set is obtained after each personal name in the candidate personal name set is compared with the preset evaluation threshold.

S405: The server takes each personal name in the target personal name set as a personal name tag of the short video.

After a personal name of at least one key person is screened from the candidate personal name set, the screened at least one personal name is taken as the personal name tag of the short video, thereby completing personal name tag tagging of the short video.

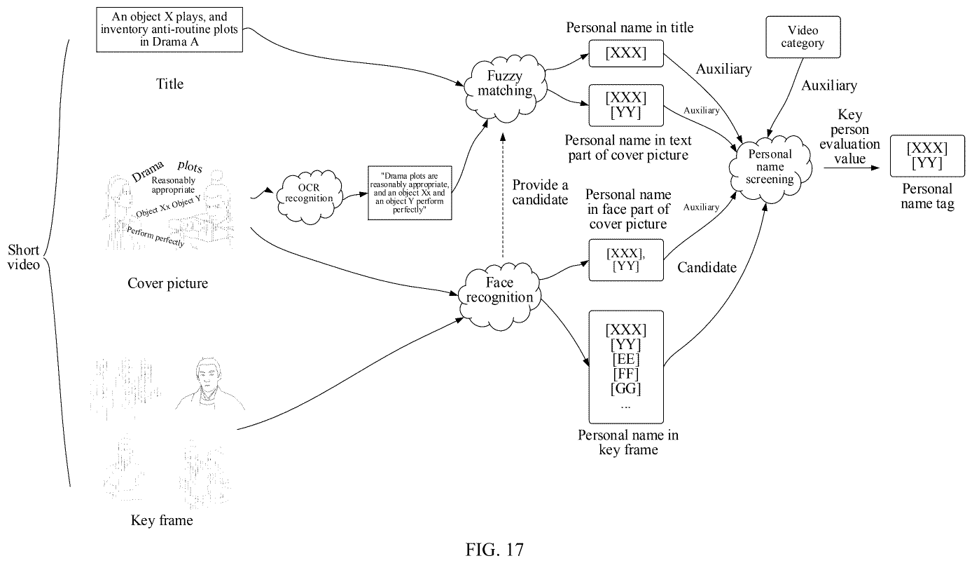

Refer to FIG. 17, which is a schematic diagram of an overall process of tagging a short video with a personal name tag. Video auxiliary information of the short video is text extracted from a title and a cover picture, and 60 key frames are extracted from the short video. First, face recognition is performed on each key frame, a personal name corresponding to a recognized face is obtained, and the personal name obtained from each key frame is taken as a candidate of a personal name tag. Then, the text in the cover picture is extracted through OCR recognition, word segmentation is performed on a title “an object X plays, and inventory anti-routine plots in Drama A” and a text part “Drama plots are reasonably appropriate, and an object Xx and an object Y perform perfectly” of the cover picture, fuzzy matching is performed on segmented words and the personal name in the key frame to obtain the personal name appearing in the title and the text part of the cover picture, and meanwhile, face recognition is performed on the cover picture to obtain the personal name of the face in the cover picture. Finally, the personal name extracted from the cover picture and the personal name extracted from the title are taken as personal names in the auxiliary personal name set obtained by screening the personal names in the key frames, and a correlation between the personal names is learned through a multihead attention mechanism, so as to purify the personal names in the candidate personal name set, and obtain a personal name that may serve as the personal name tag of the short video.

According to the short video tag generation method provided in this embodiment of the present disclosure, during tagging a short video with a personal name tag, a candidate personal name set is extracted from a plurality of key frames extracted from the short video to obtain a candidate personal name tag of the short video. Because there are many complex personal names in the candidate personal name set, which cannot be directly used as a personal name tag, a screening mode based on multimodal information extraction and fusion is designed, and video auxiliary information in a plurality of modalities such as a title and a cover picture is introduced. The video auxiliary information usually includes a key person of the short video, and important basis is provided for screening a target personal name tag, so as to screen a correct personal name tag from the candidate personal name set, thereby improving a recall rate of the personal name tag. In addition, during screening, a multihead attention mechanism is introduced, so that a mutual relationship between a candidate personal name and an auxiliary personal name extracted from the video auxiliary information and a mutual relationship between the candidate personal names can be fully learned, and an incorrect personal name tag can be well filtered out, thereby improving accuracy of a video tag system.

After the short video is accurately tagged with the personal name tag, the personal name tag of the short video may be applied to downstream services (such as: video recommendation, video search, and video distribution). Specifically, in response to a target service request, the server matches the target personal name associated with the target service request with the personal name tag of each short video in a multimedia application, and presents at least one matched target short video to a target object based on each obtained matching result.

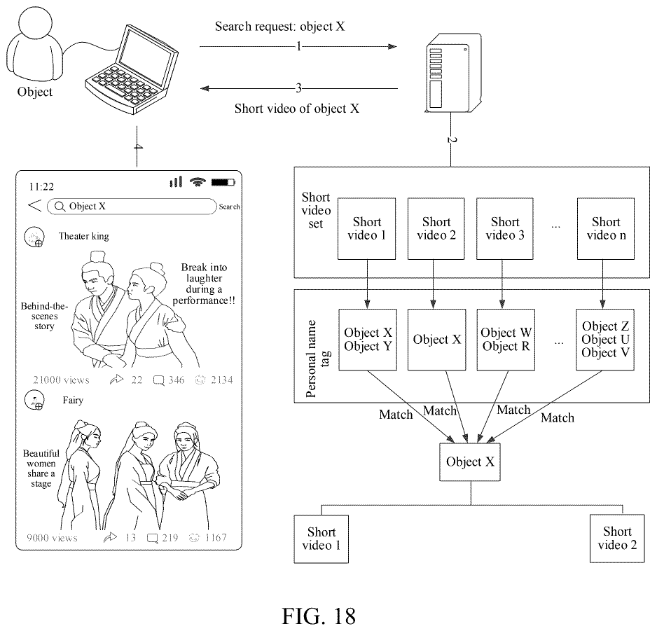

Taking an example in which the target service is video search, as shown in FIG. 18, after the target object enters a personal name “object X” into a search bar of the multimedia application and clicks a “search” option, a terminal device sends a search request to the server of the multimedia application. The search request carries the personal name “object X” entered by the target object. The server has already tagged each short video in a short video set with the personal name tag in advance through the foregoing screening mode based on multimodal information extraction and fusion. After receiving the search request, the server matches the personal name tag of each short video in the short video set with the “object X” to obtain a short video 1 and a short video 2 related to the object X, and presents the short video 1 and the short video 2 to the target object through the terminal device.

In an actual application, the short video is accurately tagged with the personal name tag, so that a downstream service quickly and accurately responds to a short video of a person that the target object likes, thereby improving a response effect of the downstream service, and improving user experience of the target object on the multimedia application.

Based on a same technical concept, the embodiments of the present disclosure provide a schematic structural diagram of a short video tag generation apparatus. The generation apparatus can implement the foregoing short video tag generation method, and can achieve a same technical effect.

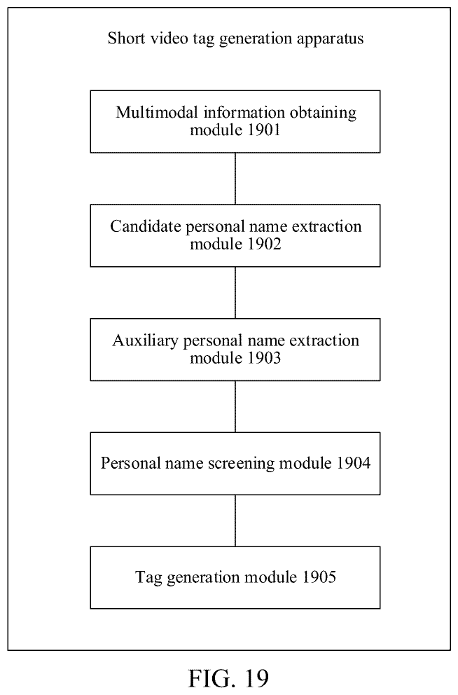

Referring to FIG. 19, the apparatus includes: a multimodal information obtaining module 1901, a candidate personal name extraction module 1902, an auxiliary personal name extraction module 1903, a personal name screening module 1904, and a tag generation module 1905.

The multimodal information obtaining module 1901 is configured to obtain a video, and obtain video auxiliary information. The video auxiliary information includes at least one of text information and picture information.

The candidate personal name extraction module 1902 is configured to extract a plurality of key frames from the video, perform face recognition on each key frame to obtain a recognition result corresponding to each key frame, and extract, based on each recognition result, a personal name corresponding to a corresponding key frame to obtain a candidate personal name set formed by the personal names corresponding to the key frames.

The auxiliary personal name extraction module 1903 is configured to perform personal name extraction on the video auxiliary information to obtain an auxiliary personal name set. The auxiliary personal name set includes at least one personal name and a personal name source of each personal name.

The personal name screening module 1904 is configured to: obtain an importance feature of each personal name in the candidate personal name set based on the auxiliary personal name set, the importance feature of each personal name including a feature vector indicating the personal name source of the corresponding personal name, and screen a target personal name set from the candidate personal name set based on the importance feature of each personal name.

The tag generation module 1905 is configured to take each personal name in the target personal name set as a personal name tag of the video.

According to the video tag generation apparatus provided in this embodiment of the present disclosure, considering that personal names included in video auxiliary information such as a title and a cover picture of a video are of relatively high importance, but personal names of key persons may be incomplete, and there are many and complex personal names in video frames included in the video, so the candidate personal name set may be obtained according to a plurality of key frames extracted from the video, the personal names in the video auxiliary information such as the title and the cover picture are enriched by the candidate personal name set, and meanwhile, the personal names in the video auxiliary information such as the title and the cover picture are taken as an auxiliary of important personal names in the key frames to obtain an auxiliary personal name set. Therefore, personal name tags in the plurality of key frames are screened by using the importance of the personal names in the video auxiliary information such as the title and the cover picture, thereby improving purity of the personal name tags, and further improving accuracy of the downstream services corresponding to the personal name tags.

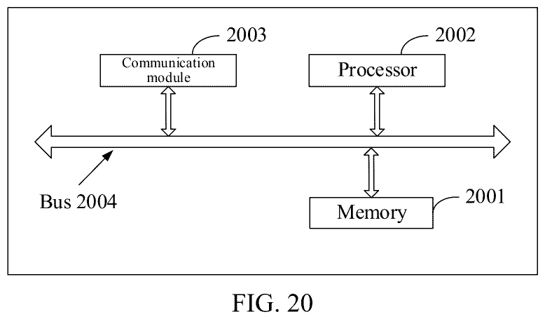

Based on a same inventive concept as the foregoing method embodiment, the embodiments of the present disclosure further provide an electronic device. In an embodiment, the electronic device may be the server in FIG. 1. In this embodiment, a structure of the electronic device may be shown in FIG. 20, and includes a memory 2001, a communication module 2003, and one or more processors 2002.

The memory 2001 is configured to store a computer program executed by the processor 2002. The memory 2001 may mainly include a program storage area and a data storage area. The program storage area may store an operating system, a computer program required for running an instant messaging function, and the like. The data storage area may store various types of instant messaging information, an operation instruction set, and the like.

The memory 2001 may be a volatile memory, for example, a random-access memory (RAM). The memory 2001 may alternatively be a non-volatile memory, for example, a read-only memory (ROM), a flash memory, a hard disk drive (HDD), or a solid-state drive (SSD). Alternatively, the memory 2001 is any other medium that can be configured to carry or store a desired computer program in a form of instructions or a data structure and can be accessed by a computer, but is not limited thereto. The memory 2001 may be a combination of the foregoing memories.

The processor 2002 may include one or more central processing units (CPUs), a digital processing unit, or the like. The processor 2002 is configured to implement the foregoing video tag generation method when invoking the computer program stored in the memory 2001.

The communication module 2003 is configured to communicate with a terminal device and another server.

A specific connection medium among the memory 2001, the communication module 2003, and the processor 2002 is not limited in the embodiments of the present disclosure. In the embodiments of the present disclosure, the memory 2001 is connected to the processor 2002 through a bus 2004 in FIG. 20. The bus 2004 is described with a thick line in FIG. 20. A connection mode between other components is merely described schematically and is not intended to limit. The bus 2004 may be classified into an address bus, a data bus, a control bus, or the like. For ease of description, FIG. 20 describes with only one thick line, but does not describe that there is only one bus or only one type of bus.

The memory 2001 stores a computer storage medium. The computer storage medium stores computer executable instructions. The computer executable instructions are configured for implementing the video tag generation method according to an embodiment of the present disclosure. The processor 2002 is configured to perform operations of the foregoing video tag generation method.

In some embodiments, various aspects of the video tag generation method provided in the present disclosure may alternatively be implemented in a form of a program product, which includes a computer program. When the computer program runs on an electronic device, the computer program is configured for enabling the electronic device to perform operations of the video tag generation method according to various exemplary embodiments of the present disclosure of the foregoing description of this specification.

The program product may be one or any combination of more readable media. The readable medium may be a readable signal medium or a readable storage medium. The readable storage medium may be, for example, but is not limited to, a system, an apparatus, or a device of electricity, magnetism, optics, electromagnetism, infrared, or semi-conductors, or any combination thereof. More specific examples (a non-exhaustive list) of the readable storage medium include: an electrical connection having one or more wires, a portable disk, a hard disk, a RAM, a ROM, an erasable programmable ROM (EPROM or a flash memory), an optical fiber, a portable compact disc ROM (CD-ROM), an optical storage device, a magnetic storage device, or any appropriate combination thereof.

The program product in an implementation of the present disclosure may adopt the portable CD-ROM, include program codes, and may run on an electronic device. However, the program product of the present disclosure is not limited thereto. In this specification, the readable storage medium may be any tangible medium including or storing a program, and the program may be used by or used in combination with an instruction execution system, apparatus, or device.

The readable signal medium may include a data signal in a baseband or propagated as a part of a carrier, which carries computer-readable program code. The data signal propagated in such a way may adopt a plurality of forms, including, but not limited to, an electromagnetic signal, an optical signal, or any appropriate combination thereof. The readable storage medium may alternatively be any readable medium other than a readable storage medium, and the readable storage medium may send, propagate, or transmit a program used by or used in combination with an instruction execution system, apparatus, or device.

The computer program included in the readable medium may be transmitted by using any appropriate medium, including but not limited to: a wireless medium, a wired medium, an optical cable, RF, and the like, or any appropriate combination thereof.

The computer program configured for performing the operations of the present disclosure may be programmed by using one programming language or an appropriate combination of more programming languages. The programming languages include object-oriented programming languages such as Java and C++, and further include a procedural programming language such as “C” or similar programming languages. The program code may be completely executed on an electronic device, partially executed on an electronic device, executed as an independent software package, partially executed on an electronic device and partially executed on a remote electronic device, or completely executed on a remote electronic device or a server. In cases involving the remote electronic device, the remote electronic device may be connected to an electronic device through any type of network including a local area network (LAN) or a wide area network (WAN), or may be connected to an external electronic device (for example, connected through the Internet by using an Internet service provider).

Although several units or subunits of an apparatus are mentioned in the detailed descriptions above, the division is only an example rather than a restriction. Actually, according to the implementations of the present disclosure, features and functions of two or more units described above may be specifically embodied in one unit. On the contrary, the features and functions of one unit described above may be further divided to be embodied by a plurality of units.

In addition, although the operations of the method in the present disclosure are described in specific order in accompanying drawings, this does not require or imply that these operations have to be performed in the specific order, or all the operations shown have to be performed to achieve an expected result. Additionally or alternatively, some operations may be omitted, the plurality of operations may be combined into one operation to perform, and/or one operation may be decomposed into a plurality of operations for performing.

A person skilled in the art can understand that the embodiments of the present disclosure may be provided as a method, a system, or a computer program product. Therefore, the present disclosure may adopt a form of hardware-only embodiments, software-only embodiments, or embodiments combining software and hardware. Moreover, the present disclosure may use a form of a computer program product that is implemented on one or more computer-usable storage media (including but not limited to a disk memory, a CD-ROM, an optical memory, and the like) that include computer-usable program code.

The present disclosure is described with reference to flowcharts and/or block diagrams of the method, the device (system), and the computer program product according to the embodiments of the present disclosure. It is to be understood that computer program instructions can implement each procedure and/or block in the flowcharts and/or block diagrams and a combination of procedures and/or blocks in the flowcharts and/or block diagrams. These computer program instructions may be provided to a general-purpose computer, a special-purpose computer, an embedded processor, or a processor of another programmable data processing device to generate a machine, so that an apparatus configured to implement functions specified in one or more procedures in the flowcharts and/or one or more blocks in the block diagrams is generated by using instructions executed by the computer or the processor of another programmable data processing device.

These computer program instructions may alternatively be stored in a computer-readable memory that can instruct a computer or another programmable data processing device to work in a specific mode, so that the instructions stored in the computer-readable memory generate an artifact that includes an instruction apparatus. The instruction apparatus implements a specific function in one or more procedures in the flowcharts and/or in one or more blocks in the block diagrams.

These computer program instructions may further be loaded onto a computer or another programmable data processing device, so that a series of operations are performed on the computer or another programmable device, thereby generating computer-implemented processing. Therefore, the instructions executed on the computer or another programmable device provide operations for implementing a specific function in one or more processes in the flowcharts and/or in one or more blocks in the block diagrams.

Apparently, a person skilled in the art can make various modifications and variations to the present disclosure without departing from the spirit and scope of the present disclosure. In this way, if the modifications and variations made to the present disclosure fall within the scope of the claims of the present disclosure and their equivalent technologies, the present disclosure is intended to include these modifications and variations.

What is claimed is:

1. A video tag generation method, performed by a server, and comprising:
obtaining a video and obtaining video auxiliary information, the video auxiliary information comprising at least one of text information and picture information;
extracting a plurality of key frames from the video, performing face recognition on each key frame to obtain a recognition result corresponding to each key frame;
extracting, based on each recognition result, a personal name corresponding to a corresponding key frame, to obtain a candidate personal name set comprising personal names corresponding to the plurality of key frames;
performing personal name extraction on the video auxiliary information to obtain an auxiliary personal name set, the auxiliary personal name set comprising at least one personal name and a personal name source of each of the at least one personal name;
obtaining an importance feature of each personal name in the candidate personal name set based on the auxiliary personal name set, the importance feature of each personal name comprising a feature vector indicating the personal name source of the corresponding personal name; and determining a target personal name set by screening the candidate personal name set based on the importance feature of each personal name; and
taking each personal name in the target personal name set as a personal name tag of the video.

2. The method according to claim 1, wherein the performing personal name extraction on the video auxiliary information to obtain an auxiliary personal name set comprises:
in response to that the video auxiliary information comprises at least one piece of text information, performing personal name extraction on each piece of text information to obtain a personal name comprised in each piece of text information, and taking an information source of each piece of text information as a personal name source of each personal name comprised in the corresponding text information, wherein the at least one piece of text information comprises original text associated with the video and a text part extracted from the picture information; and
obtaining an auxiliary personal name set based on the personal name comprised in each piece of text information and the personal name source of the corresponding personal name.

3. The method according to claim 2, wherein the performing personal name extraction on a piece of text information comprises:
performing word segmentation on the piece of text information;
traversing each personal name in the candidate personal name set, and calculating a character string edit distance between the personal name and each segmented word; and
taking, as the personal name comprised in the piece of text information in each character string edit distance, a segmented word corresponding to the character string edit distance meeting a preset distance threshold requirement.

4. The method according to claim 2, wherein the performing personal name extraction on the video auxiliary information to obtain an auxiliary personal name set further comprises:
in response to that the video auxiliary information comprises at least one piece of picture information, performing face recognition on each piece of picture information to obtain a recognition result corresponding to each piece of picture information, extracting, based on each recognition result, a personal name corresponding to the corresponding picture information, and taking an information source of each piece of picture information as the personal name source of each personal name corresponding to the corresponding picture information; and
obtaining the auxiliary personal name set based on the personal name corresponding to each piece of picture information and the personal name source of the corresponding personal name.

5. The method according to claim 1, wherein the obtaining an importance feature of each personal name in the candidate personal name set based on the auxiliary personal name set comprises:
obtaining the personal name source of each personal name in the candidate personal name set based on the auxiliary personal name set; and
obtaining, based on the personal name source of each personal name, a feature vector indicating the personal name source of the corresponding personal name, and adding, to the importance feature of the corresponding personal name, the feature vector indicating the personal name source of the corresponding personal name, wherein the feature vector indicating the personal name source of the corresponding personal name comprises feature values corresponding to a plurality of personal name sources, a feature value corresponding to each personal name source comprised in the personal name source of the corresponding personal name is set to a first value, and a feature value corresponding to each personal name source not comprised in the personal name source of the corresponding personal name is set to a second value.

6. The method according to claim 1, wherein when obtaining the importance feature of each personal name, the method further comprises at least one of:
obtaining, based on the recognition result of each key frame, confidence of a face recognized in the corresponding key frame, and adding the confidence of the face corresponding to each personal name to an importance feature of the corresponding personal name; and
obtaining, based on the recognition result of each key frame, a frame sequence number of the key frame in which the face corresponding to each personal name is located, and adding the frame sequence number corresponding to each personal name to the importance feature of the corresponding personal name.

7. The method according to claim 1, wherein during obtaining the importance feature of each personal name, the method further comprises:
identifying a video category of the video, and adding the video category to the importance feature of each personal name.

8. The method according to claim 1, wherein the determining a target personal name set by screening the candidate personal name set based on the importance feature of each personal name comprises:
obtaining a key person evaluation value of the corresponding personal name based on the importance feature of each personal name; and
screening the target personal name set from the candidate personal name set based on the key person evaluation value of each personal name.

9. The method according to claim 1, wherein a process of screening the target personal name set is performed through a target screening model.

10. The method according to claim 9, wherein the target screening model is trained by:
generating, based on a preset video set and the video auxiliary information of each video, a training sample set, wherein each training sample in the training sample set comprises a candidate sample personal name set, an auxiliary sample personal name set, and a real sample personal name tag corresponding to one video; the candidate sample personal name set comprises a plurality of sample personal names; and the auxiliary sample personal name set comprises at least one sample personal name and a personal name source of each sample personal name; and
performing, based on the training sample set, a plurality of rounds of iterative training on a screening model to be trained to obtain the target screening model, wherein for a training sample in the training sample set in each iteration:
obtaining, based on the auxiliary sample personal name set corresponding to the training sample, an importance feature of each sample personal name in the candidate sample personal name set corresponding to the training sample, the importance feature of each sample personal name comprising a feature vector indicating a personal name source of the corresponding sample personal name;
obtaining, by using a plurality of attention layers and a normal layer and based on the importance feature of each sample personal name, a predicted sample personal name tag of the candidate sample personal name set corresponding to the training sample;
obtaining a tag loss value by using a mean square error loss function and based on the predicted sample personal name tag and the real sample personal name tag of the candidate sample personal name set corresponding to the training sample; and
adjusting a network parameter of the screening model based on the tag loss value.

11. The method according to claim 10, further comprising:
for each training sample in the training sample set, performing:
obtaining a quantity of the sample personal names in the candidate sample personal name set corresponding to the training sample;
if the quality is greater than a preset quantity threshold, selecting, based on a quantity of frames that each sample personal name in the candidate sample personal name set corresponding to the training sample appears in a corresponding video, part sample personal names in the candidate sample personal name set corresponding to the training sample;
if the quantity is less than the preset quantity threshold, increasing, in a mode of adding a zero vector, the quantity of the sample personal names in the candidate sample personal name set corresponding to the training sample; and
updating the training sample set based on the selected part sample personal names or an added zero vector.

12. The method according to claim 1, further comprising:
in response to a target service request, matching a target personal name associated with the target service request with the personal name tag of each video in a multimedia application; and
presenting at least one matched target video to a target object based on each obtained matching result.

13. The method according to claim 1, wherein the text information comprises at least one of a title, a subtitle, and a comment of the video; and
the picture information comprises at least one of a cover picture and a poster of the video.

14. A video tag generation apparatus, applied to a server, and comprising:
a processor and a memory, wherein the memory stores a computer program, and the computer program, when executed by the processor, enables the processor to perform:
obtaining a video and obtaining video auxiliary information, the video auxiliary information comprising at least one of text information and picture information;
extracting a plurality of key frames from the video, performing face recognition on each key frame to obtain a recognition result corresponding to each key frame;
extracting, based on each recognition result, a personal name corresponding to a corresponding key frame, to obtain a candidate personal name set comprising personal names corresponding to the plurality of key frames;
performing personal name extraction on the video auxiliary information to obtain an auxiliary personal name set, the auxiliary personal name set comprising at least one personal name and a personal name source of each of the at least one personal name;
obtaining an importance feature of each personal name in the candidate personal name set based on the auxiliary personal name set, the importance feature of each personal name comprising a feature vector indicating the personal name source of the corresponding personal name; and determining a target personal name set by screening the candidate personal name set based on the importance feature of each personal name; and
taking each personal name in the target personal name set as a personal name tag of the video.

15. The apparatus according to claim 14, wherein the performing personal name extraction on the video auxiliary information to obtain an auxiliary personal name set comprises:
in response to that the video auxiliary information comprises at least one piece of text information, performing personal name extraction on each piece of text information to obtain a personal name comprised in each piece of text information, and taking an information source of each piece of text information as a personal name source of each personal name comprised in the corresponding text information, wherein the at least one piece of text information comprises original text associated with the video and a text part extracted from the picture information; and
obtaining an auxiliary personal name set based on the personal name comprised in each piece of text information and the personal name source of the corresponding personal name.

16. The apparatus according to claim 15, wherein the performing personal name extraction on a piece of text information comprises:
performing word segmentation on the piece of text information;
traversing each personal name in the candidate personal name set, and calculating a character string edit distance between the personal name and each segmented word; and
taking, as the personal name comprised in the piece of text information in each character string edit distance, a segmented word corresponding to the character string edit distance meeting a preset distance threshold requirement.

17. The apparatus according to claim 15, wherein the performing personal name extraction on the video auxiliary information to obtain an auxiliary personal name set further comprises:
in response to that the video auxiliary information comprises at least one piece of picture information, performing face recognition on each piece of picture information to obtain a recognition result corresponding to each piece of picture information, extracting, based on each recognition result, a personal name corresponding to the corresponding picture information, and taking an information source of each piece of picture information as the personal name source of each personal name corresponding to the corresponding picture information; and
obtaining the auxiliary personal name set based on the personal name corresponding to each piece of picture information and the personal name source of the corresponding personal name.

18. The apparatus according to claim 14, wherein the obtaining an importance feature of each personal name in the candidate personal name set based on the auxiliary personal name set comprises:
obtaining the personal name source of each personal name in the candidate personal name set based on the auxiliary personal name set; and
obtaining, based on the personal name source of each personal name, a feature vector indicating the personal name source of the corresponding personal name, and adding, to the importance feature of the corresponding personal name, the feature vector indicating the personal name source of the corresponding personal name, wherein the feature vector indicating the personal name source of the corresponding personal name comprises feature values corresponding to a plurality of personal name sources, a feature value corresponding to each personal name source comprised in the personal name source of the corresponding personal name is set to a first value, and a feature value corresponding to each personal name source not comprised in the personal name source of the corresponding personal name is set to a second value.

19. The apparatus according to claim 14, wherein when obtaining the importance feature of each personal name, the processor is further configured to perform at least one of:
obtaining, based on the recognition result of each key frame, confidence of a face recognized in the corresponding key frame, and adding the confidence of the face corresponding to each personal name to an importance feature of the corresponding personal name; and
obtaining, based on the recognition result of each key frame, a frame sequence number of the key frame in which the face corresponding to each personal name is located, and adding the frame sequence number corresponding to each personal name to the importance feature of the corresponding personal name.

20. A non-transitory computer-readable storage medium, comprising a computer program, wherein the computer program, when running on an electronic device, is configured for enabling the electronic device to perform:
obtaining a video and obtaining video auxiliary information, the video auxiliary information comprising at least one of text information and picture information;
extracting a plurality of key frames from the video, performing face recognition on each key frame to obtain a recognition result corresponding to each key frame;
extracting, based on each recognition result, a personal name corresponding to a corresponding key frame, to obtain a candidate personal name set comprising personal names corresponding to the plurality of key frames;
performing personal name extraction on the video auxiliary information to obtain an auxiliary personal name set, the auxiliary personal name set comprising at least one personal name and a personal name source of each of the at least one personal name;
obtaining an importance feature of each personal name in the candidate personal name set based on the auxiliary personal name set, the importance feature of each personal name comprising a feature vector indicating the personal name source of the corresponding personal name; and determining a target personal name set by screening the candidate personal name set based on the importance feature of each personal name; and
taking each personal name in the target personal name set as a personal name tag of the video.
